(19) United States
(12) Patent Application Publication
(10) Pub. No.: US 2024/0419028 A1
(43) Pub. Date: Dec. 19, 2024

(54) DISPLAY APPARATUS AND ARRAY SUBSTRATE

(71) Applicant: Japan Display Inc., Tokyo (JP)

(72) Inventor: Kyosuke WATANABE, Tokyo (JP)

(21) Appl. No.: 18/732,698

(22) Filed: Jun. 4, 2024

(30) Foreign Application Priority Data
Jun. 19, 2023 (JP) 2023-099934

(51) Int. Cl. G02F 1/1335; G02F 1/1343

(52) U.S. Cl. CPC G02F 1/133502; G02F 1/133514; G02F 1/134318; G02F 2201/123

(57) ABSTRACT

Reflection of external light is reduced. In the present disclosure, a display apparatus includes: an organic insulating film; a high-refractive-index film being in contact with the organic insulating film; a pixel electrode being in contact with the high-refractive-index film; a capacitance insulating film being in contact with the pixel electrode; and a common electrode being in contact with the capacitance insulating film. In this case, a refractive index of the high-refractive-index film is higher than a refractive index of the organic insulating film.

### CROSS-REFERENCE TO RELATED APPLICATION

The present application claims priority to Japanese Patent Application No. 2023-99934 filed on Jun. 19, 2023, the disclosure of which is incorporated herein by reference.

### TECHNICAL FIELD OF THE INVENTION

The present invention relates to a technique effectively applied to a display apparatus and an array substrate.

### BACKGROUND OF THE INVENTION

Japanese Patent Application Laid-open Publication No. 2022-153055 (Patent Document 1) discloses a technique relating to a display apparatus and an array substrate each using a thin film transistor including an oxide semiconductor.

### SUMMARY OF THE INVENTION

In a display apparatus, it is desirable to reduce reflection of external light in order to improve visible recognition.

A display apparatus according to an embodiment includes: an organic insulating film; a high-refractive-index film being in contact with the organic insulating film; a pixel electrode being in contact with the high-refractive-index film; a capacitance insulating film being in contact with the pixel electrode; and a common electrode being in contact with the capacitance insulating film, and a refractive index of the high-refractive-index film is higher than a refractive index of the organic insulating film.

A display apparatus according to an embodiment includes: a color filter; a high-refractive-index film being in contact with the color filter; a pixel electrode being in contact with the high-refractive-index film; a capacitance insulating film being in contact with the pixel electrode; and a common electrode being in contact with the capacitance insulating film, and a refractive index of the high-refractive-index film is higher than a refractive index of the color filter.

An array substrate according to an embodiment includes: a color filter; a high-refractive-index film being in contact with the color filter; a pixel electrode being in contact with the high-refractive-index film; a capacitance insulating film being in contact with the pixel electrode; and a common electrode being in contact with the capacitance insulating film, and a refractive index of the high-refractive-index film is higher than a refractive index of the color filter.

### BRIEF DESCRIPTIONS OF THE DRAWINGS

FIG. 1 is an exploded perspective view illustrating a schematic configuration example of a liquid crystal display apparatus.

FIG. 2 is a plan view illustrating an outline configuration of a display panel.

FIG. 3 is a plan view illustrating an example of a planar layout of subpixels.

FIG. 4 is an outline plan view illustrating a part of elements configuring the subpixel.

FIG. 5 is a schematic cross-sectional view taken along a line A-A in FIG. 4.

FIG. 6 is a schematic view illustrating a configuration example of a conductive film.

FIG. 7 is a simplified schematic plan view of FIG. 4.

FIG. 8 is a schematic cross-sectional view taken along a line A-A in FIG. 7.

FIG. 9 is a view for explaining an embodied aspect and is a schematic cross-sectional view corresponding to the cross section taken along the line A-A in FIG. 7.

FIG. 10 is a view for explaining a modification example and is a schematic cross-sectional view corresponding to the cross section taken along the line A-A in FIG. 7.

### DESCRIPTIONS OF THE PREFERRED EMBODIMENTS

Hereinafter, embodiments will be explained with reference to the drawings.

Note that the present disclosure is only one example, and appropriate modification with keeping the idea of the present invention which can be anticipated by those who are skilled in the art is obviously within the scope of the present disclosure.

Also, in order to make the explanation clearer, a width, a thickness, a shape, and others of each portion in the drawings are schematically illustrated more than those in an actual aspect in some cases. However, the illustration is only one example, and does not limit the interpretation of the present disclosure. In the present specification and each drawing, similar elements to those illustrated in the already-described drawings are denoted with the same reference characters, and detailed explanation for them is appropriately omitted in some cases.

In the present embodiment, for example, a liquid crystal display apparatus including a liquid crystal display element is disclosed. However, the embodiment does not prevent the application of the technical idea disclosed in the embodiment to a display apparatus including another type of display element represented by, for example, an organic electroluminescence display element, a micro LED, or a mini LED. In addition, the technical idea disclosed in the embodiment is also applicable to an electronic device or an array substrate including a sensor element represented by a capacitive sensor, an optical sensor, or the like.

### <Overall Configuration of Liquid Crystal Display Apparatus>

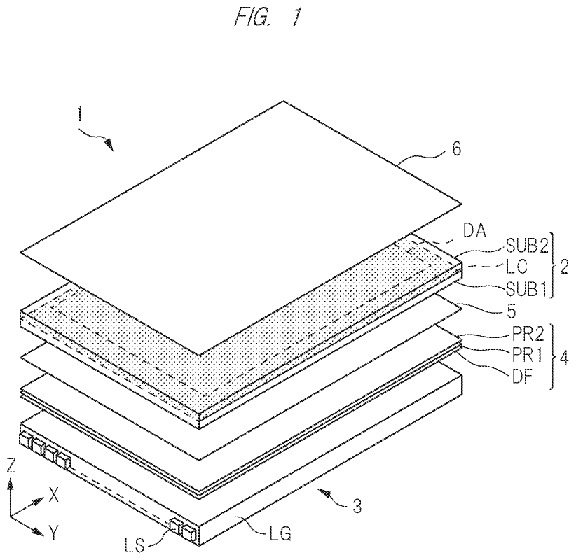

FIG. 1 is an exploded perspective view illustrating a schematic configuration example of a liquid crystal display apparatus 1. As illustrated in FIG. 1, an X direction, a Y direction, and a Z direction are defined. The X direction, the Y direction, and the Z direction are directions orthogonal to one another, but may intersect one another at an angle other than a vertical angle. Viewing the liquid crystal display apparatus 1 and components thereof in parallel with the Z direction is referred to as “plan view”. In addition, the direction indicated by the arrow of the Z direction may be referred to as “upper side”, and the opposite direction may be referred to as “lower side”.

In FIG. 1, the liquid crystal display apparatus 1 includes a display panel 2 and a backlight 3. For example, the backlight 3 can be made of a side-edge-type backlight including a light guide body LG facing the display panel 2 and a plurality of light emitting elements LS arranged at positions facing a side surface of the light guide body LG. However, the backlight 3 is not limited to this example, and a backlight with various configurations that can supply light required for image display can be adopted.

The planar shape of each of the display panel 2 and the light guide body LG is made of, for example, a rectangular shape having a long side along the X direction and a short side along the Y direction, but is not limited to the rectangular shape, and may be made of another shape.

The display panel 2 is a liquid crystal panel having light transmitting property, and includes, for example, an array substrate SUB1, a counter substrate SUB2 facing the array substrate SUB1, and a liquid crystal layer LC filling to seal a gap between the array substrate SUB1 and the counter substrate SUB2. The display panel 2 configured as described above includes, for example, a rectangular display region DA.

The liquid crystal display apparatus 1 further includes an optical sheet group 4, a polarizer 5 and a polarizer 6. The optical sheet group 4 is arranged between the light guide body LG and the display panel 2. For example, the optical sheet group 4 includes a diffusion sheet DF that diffuses light emitted from the light guide body LG and a prism sheet PR1 and a prism sheet PR2 each including a large number of prisms formed therein.

The polarizer 5 is arranged between the optical sheet group 4 and the array substrate SUB1. On the other hand, the polarizer 6 is arranged on the upper side of the counter substrate SUB2. Here, a relationship between a polarization axis of the polarizer 5 and a polarization axis of the polarizer 6 is a crossed-Nicols relationship in which the polarization axes are orthogonal to each other.

The liquid crystal display apparatus 1 configured as described above can be used for various types of devices represented by, for example, a head mounted display, an in-vehicle device, a smartphone, a tablet terminal device, a mobile phone, a personal computer, a television receiver, and a game device.

### <Configuration of Display Panel>

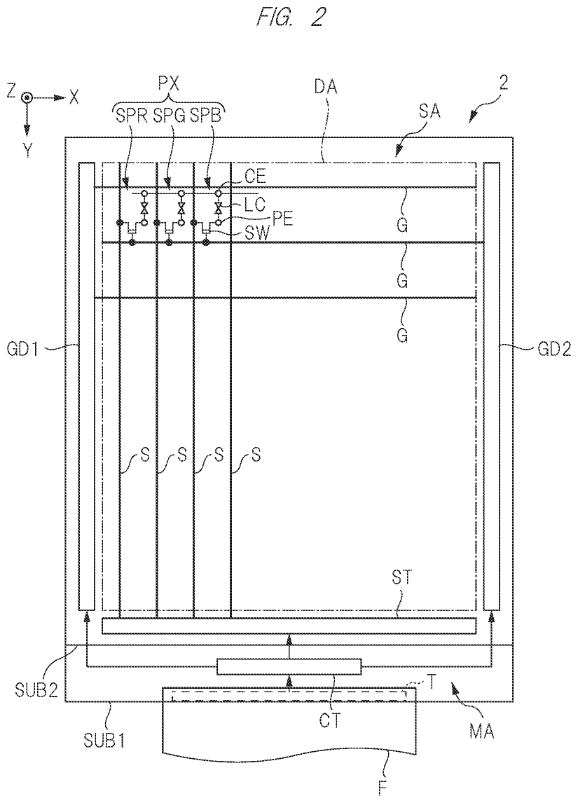

Next, a configuration of the display panel 2 will be explained. FIG. 2 is a plan view illustrating an outline configuration of the display panel 2. In FIG. 2, the display panel 2 includes the display region DA and a peripheral region SA around the display region DA. For example, as illustrated in FIG. 2, a lower side of the array substrate SUB1 protrudes from the counter substrate SUB2 in the Y direction. Thus, the array substrate SUB1 includes a mounting region MA that does not overlap the counter substrate SUB2 in a plan view. The mounting region MA configures a part of the peripheral region SA.

In the display region DA, a plurality of pixels PX are arranged in a matrix pattern. The pixel PX includes a plurality of subpixels. For example, in FIG. 2, the pixel PX includes a red subpixel SPR, a green subpixel SPG, and a blue subpixel SPB. However, the pixel PX is not limited to such a configuration, and may be configured to include subpixels of other colors represented by white.

As illustrated in FIG. 2, the display panel 2 includes a plurality of scan lines G, a plurality of signal lines S (video lines), a scanning driver GD1, a scanning driver GD2, and a selector circuit ST. The plurality of scan lines G extend in the X direction and also are arranged in the Y direction. On the other hand, the plurality of signal lines S extend in the Y direction and also are arranged in the X direction. Each of the plurality of scan line G is connected to the scanning driver GD1 or the scanning driver GD2. On the other hand, each of the plurality of signal lines S is connected to the selector circuit ST.

Next, as illustrated in FIG. 2, a controller CT is mounted on the mounting region MA. In addition, a terminal portion T is provided on the mounting region MA, and a flexible substrate F is connected to the terminal portion T. Note that the controller CT may be mounted on the flexible substrate F. The controller CT is made of, for example, an IC chip or a circuit element.

Various types of signals transmitted from the electronic device on which the liquid crystal display apparatus 1 is mounted are output to the controller CT via an integrated circuit mounted on the flexible substrate F. The controller CT receives such a signal as its input, supplies a video signal to the selector circuit ST, and controls the scanning driver GD1, the scanning driver GD2, and the selector circuit ST.

Each of the scanning driver GD1 and the scanning driver GD2 sequentially supplies the scan signal to the plurality of scan lines G. On the other hand, the selector circuit ST sequentially supplies the video signal input from the controller CT to the signal line S.

The pixel PX is configured to include a pixel electrode PE, a switching element SW (thin film transistor), and a common electrode CE to which a common potential is supplied. The switching element SW is connected to the pixel electrode PE, the scan line G, and the signal line S.

For example, if the switching element SW is made of a thin film transistor (field effect transistor), a gate electrode of the thin film transistor is electrically connected to the scan line G. Further, a source of the thin film transistor is electrically connected to the signal line S while a drain of the thin film transistor is electrically connected to the pixel electrode PE.

Here, by the supply of the scan signal to the scan line G, the thin film transistor is turned on, and the video signal supplied to the signal line S is supplied to the pixel electrode PE. On the other hand, the common electrode CE is formed over the plurality of subpixels, and a potential difference is generated between the pixel electrode PE and the common electrode CE by the supply of the video signal to the pixel electrode PE. As a result of the act of the electric field generated by this on the liquid crystal layer LC, orientation directions of a plurality of liquid crystal molecules configuring the liquid crystal layer LC are controlled.

For example, in a so-called “vertical electric field mode” in which the liquid crystal layer LC is interposed between the pixel electrode PE and the common electrode CE since the pixel electrode PE is formed on the array substrate while the common electrode CE is formed on the counter substrate, the orientation directions of the plurality of liquid crystal molecules configuring the liquid crystal layer LC are controlled by a vertical electric field generated between the pixel electrode PE and the common electrode CE.

On the other hand, for example, in a so-called “transverse electric field mode” in which the pixel electrode PE and the common electrode CE are formed on the array substrate while a transverse electric field (fringe electric field) leaking from a slit in the common electrode CE is used, the orientation directions of the plurality of liquid crystal molecules configuring the liquid crystal layer LC arranged on the upper side of the array substrate are controlled by the transverse electric field leaking from the slit.

As described above, the modes for controlling the orientation directions of the liquid crystal molecules include the “vertical electric field mode” and the “transverse electric field mode”. For example, the “transverse electric field mode” has an advantage that the viewing angle can be made wider than that of the “vertical electric field mode”. The present embodiment adopts the “transverse electric field mode” in which the scan line G, the signal line S, the scanning driver GD1, the scanning driver GD2, the selector circuit ST, the switching element SW, the pixel electrode PE, and the common electrode CE are formed on the array substrate SUB1.

### <Planar Layout Configuration of Subpixels>

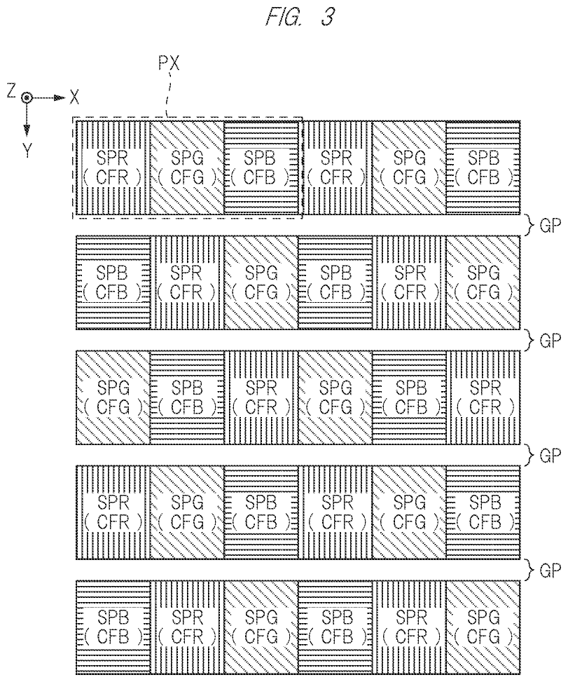

Next, a planar layout configuration of the subpixels will be explained. FIG. 3 is a plan view illustrating an example of the planar layout of the subpixels. In FIG. 3, the subpixels include a subpixel SPR, a subpixel SPG and a subpixel SPB. A red color filter CFR is arranged in the subpixel SPR, and a green color filter CFG is arranged in the subpixel SPG. Also, a blue color filter CFB is arranged in the subpixel SPB.

As illustrated in FIG. 3, the subpixels SPR, SPG, and SPB are arranged in this order in the X direction. Furthermore, the subpixels SPR, SPB, and SPG are arranged in this order in the Y direction. As a result, the subpixels SPR are arranged in an oblique direction intersecting the X direction and the Y direction. Similarly, the subpixels SPG are aligned in the oblique direction, and the subpixels SPB are aligned in the oblique direction.

The color filters CFR, CFG, and CFB are arranged in a dot pattern (island pattern) with respect to the subpixels SPR, SPG, and SPB.

And, for example, gaps GP are formed between the color filter CFR and the color filter CFG, between the color filter CFG and the color filter CFB, between the color filter CFB and the color filter CFR adjacent to each other in the Y direction, and the like.

Note that the planar layout of the subpixels SPR, SPG, and SPB and the color filters CFR, CFG, and CFB is not limited to the planar layout illustrated in FIG. 3.

For example, the subpixels SPR may be arranged in the Y direction, the subpixels SPG may be arranged in the Y direction, the subpixels SPB may be arranged in the Y direction, and a line of the subpixels SPR, a line of the subpixels SPG, and a line of the subpixels SPB may be sequentially arranged in the X direction.

As described above, the liquid crystal display apparatus 1 according to the present embodiment has so-called “color filter on array (COA) structure” in which all of the color filters CFR, CFG, and CFB are arranged on the array substrate SUB1. According to the “COA structure”, the color filters and the subpixels are provided on the same array substrate SUB1. Thus, according to the “COA structure”, the high-definition liquid crystal display apparatus 1 can be achieved without being affected by the alignment deviation between the array substrate SUB1 and the counter substrate SUB2.

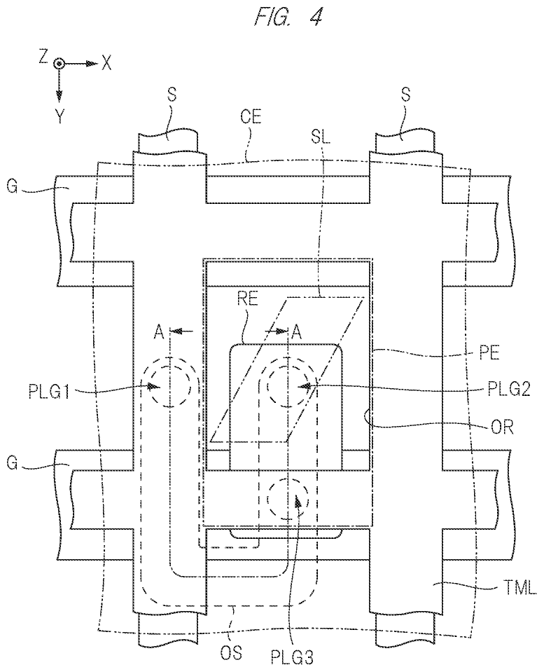

FIG. 4 is an outline plan view illustrating a part of elements configuring the subpixel. FIG. 4 shows two scan lines G extending in the X direction and two signal lines S intersecting these scan lines G and extending in the Y direction. An opening region OR of the subpixel is formed in a region surrounded by the two scan lines G and the two signal lines S. In the opening region OR, the pixel electrode PE is provided so as to overlap the opening region OR in a planar manner.

A conductive film TML is arranged on the upper side of the scan line G and the signal line S. The conductive film TML includes an X-direction extending portion extending in the X direction and a Y-direction extending portion extending in the Y direction. The X-direction extending portion is provided so as to overlap the scan line G in a planar manner. On the other hand, the Y-direction extending portion is provided so as to overlap the signal line S in a planar manner. The conductive film TML has a grid-pattern planar shape made of the X-direction extending portion and the Y-direction extending portion as a whole as illustrated in FIG. 4. The conductive film TML functions as a “light shielding film” that shields light.

Next, as illustrated in FIG. 4, at a contact portion PLG1, the signal line S is connected to a semiconductor layer OS of the thin film transistor configuring the switching element. In this manner, the contact portion PLG1 has a function of electrically connecting the semiconductor layer OS and the signal line S.

Further, the semiconductor layer OS extends so as to intersect the scan line G and reach the opening region OR and is connected to a relay electrode RE at a contact portion PLG2 positioned in the opening region OR. That is, the contact portion PLG2 has a function of electrically connecting the semiconductor layer OS and the relay electrode RE.

Further, the pixel electrode PE is provided so as to overlap the opening region OR in a planar manner, and the pixel electrode PE and the relay electrode RE are connected to each other at a bottom portion of a contact portion PLG3. That is, a part of the pixel electrode PE is formed inside the contact portion PLG3, and the part of the pixel electrode PE formed inside the contact portion PLG3 and the relay electrode RE are electrically connected to each other at the bottom portion of the contact portion PLG3. As described above, the pixel electrode PE is electrically connected to the semiconductor layer OS via the relay electrode RE. That is, the contact portion PLG3 has a function of electrically connecting the pixel electrode PE and the relay electrode RE.

Next, as illustrated in FIG. 4, for example, the common electrode CE is provided so as to overlap the entire elements such as the scan line G, the signal line S, and the conductive film TML in a planar manner. In the opening region OR, the common electrode CE is provided with the slit SL.

Here, for example, the electric field generated when the potential difference is generated between the common electrode CE and the pixel electrode PE leaks from the slit SL provided in the common electrode CE. As a result, the orientation directions of the plurality of liquid crystal molecules configuring the liquid crystal layer arranged on the upper side of the array substrate are controlled by the transverse electric field leaking from the slit SL. That is, the slit SL provided in the common electrode CE has a function of applying the transverse electric field for controlling the orientation directions of the plurality of liquid crystal molecules to the liquid crystal layer. As described above, the planar layout configuration of the subpixels is achieved.

### <Cross-Sectional Configuration of Subpixel>

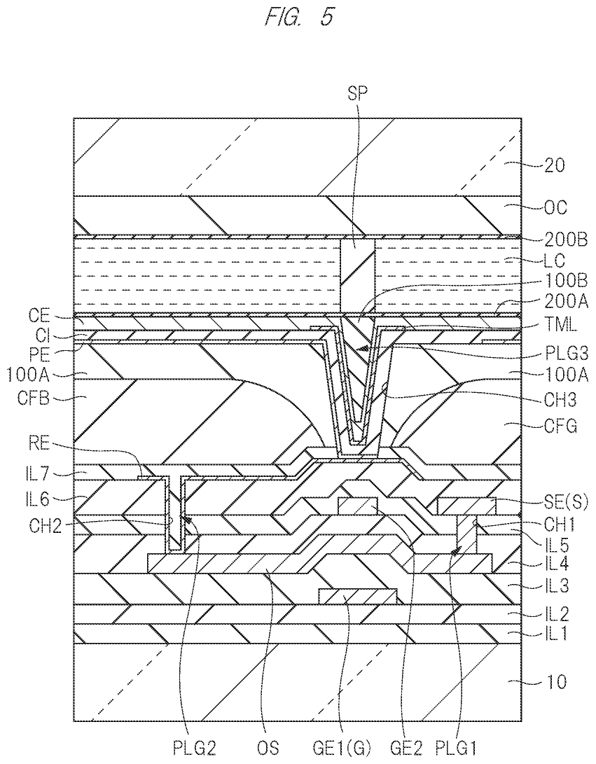

Next, a cross-sectional configuration of the subpixel will be explained. FIG. 5 is a schematic cross-sectional view taken along a line A-A in FIG. 4. Note that FIG. 5 is not a view resulted from accurate reflection of the cross section taken along the line A-A in FIG. 4 but an outline cross-sectional view. For example, although the line A-A in FIG. 4 intersects the scan line G twice, FIG. 5 shows only one scan line G (gate electrode GE1). And, although FIG. 5 shows a gate electrode GE2, FIG. 4 does not show this gate electrode GE2.

In FIG. 5, an insulating layer IL1 is formed on a substrate 10 having light transmitting property. An insulating layer IL2 is formed on the insulating layer IL1. Although the substrate 10 is made of, for example, glass, the present invention is not limited to this example. This may be made of a resin material represented by a polyimide resin. In addition, each of the insulating layer IL1 and the insulating layer IL2 is made of an inorganic insulating film represented by a silicon nitride film or a silicon oxide film.

Subsequently, as illustrated in FIG. 5, a gate electrode GE1 of the thin film transistor (field effect transistor) which is the switching element is formed on the insulating layer IL2. The gate electrode GE1 functions as the scan line G. The gate electrode GE1 is made of, for example, a metal material. The gate electrode GE1 may have a single-layer structure made of a single metal material or may have a multilayered structure in which different types of metal materials are stacked.

Next, an insulating layer IL3 is formed on the insulating layer IL2 so as to cover the gate electrode GE1. And, the semiconductor layer OS is formed on the insulating layer IL3. The insulating layer IL3 is made of, for example, an inorganic insulating film such as a silicon nitride film or a silicon oxide film. On the other hand, the semiconductor layer OS is made of an amorphous silicon film or an oxide semiconductor film.

The semiconductor layer OS functions as a channel of the thin film transistor. That is, the channel is formed in the semiconductor layer OS in accordance with a gate voltage applied to the gate electrode GE1. For example, the channel is formed in the semiconductor layer OS by application of a gate voltage equal to or larger than a threshold voltage to the gate electrode GE1. On the other hand, the channel formed in the semiconductor layer OS is disappeared by application of a gate voltage smaller than the threshold value to the gate electrode GE1.

Accordingly, on-off operations of the thin film transistor can be controlled based on the gate voltage applied to the gate electrode GE1.

For example, the semiconductor layer OS is desirably made of an oxide semiconductor film. This is because a thin film transistor using the oxide semiconductor film as the channel has advantages that are higher electron mobility than that of a thin film transistor using the amorphous silicon film as the channel and very low off-leakage current.

Next, as illustrated in FIG. 5, an insulating layer IL4 is formed on the insulating layer IL3 so as to cover the semiconductor layer OS. And, the gate electrode GE2 is formed on the insulating layer IL4. The insulating layer IL4 is made of, for example, an inorganic insulating film such as a silicon nitride film or a silicon oxide film. On the other hand, the gate electrode GE2 is made of, for example, a metal material. As described above, the thin film transistor includes the gate electrode GE1 and the gate electrode GE2 arranged so as to interpose the semiconductor layer OS from above and below. In this configuration, for example, the channel can be formed on a lower surface of the semiconductor layer OS by the application of the gate voltage equal to or larger than the threshold voltage to the gate electrode GE1 arranged on the lower side of the semiconductor layer OS, and the channel can also be formed on an upper surface of the semiconductor layer OS by the application of the gate voltage equal to or larger than the threshold voltage to the gate electrode GE2 arranged on the upper side of the semiconductor layer OS.

That is, in the thin film transistor according to the present embodiment, the channels can be formed on both the upper surface and the lower surface of semiconductor layer OS, and thus, the current driving force of the thin film transistor can be improved. However, the configuration of the thin film transistor is not limited to this example, and the gate electrode GE2 may be eliminated. Therefore, for example, FIG. 4 does not show the gate electrode GE2.

Next, an insulating layer IL5 is formed on the insulating layer IL4 so as to cover the gate electrode GE2. A source electrode SE is formed on the insulating layer IL5. The source electrode SE functions as the signal line S. The insulating layer IL5 is made of, for example, an inorganic insulating film such as a silicon nitride film or a silicon oxide film. On the other hand, the source electrode SE is made of, for example, a metal material.

Here, as illustrated in FIG. 5, in the insulating layer IL4 and the insulating layer IL5, a contact hole CH1 penetrating through these insulating layers and reaching the semiconductor layer OS is formed. At the contact hole CH1, the source electrode SE is electrically connected to the semiconductor layer OS via the contact portion PLG1.

Next, an insulating layer IL6 is formed on the insulating layer IL5 so as to cover the source electrode SE. The insulating layer IL6 is also made of, for example, an inorganic insulating film such as a silicon nitride film or a silicon oxide film. And, as illustrated in FIG. 5, a contact hole CH2 penetrating the insulating layer IL6, the insulating layer IL5, and the insulating layer IL4 and reaching the semiconductor layer OS is formed. At this time, the relay electrode RE is formed from the inside of the contact hole CH2 over the insulating layer IL6. The relay electrode RE is made of, for example, a light transmitting conductive material.

Next, an insulating layer IL7 is formed to fill the inside of the contact hole CH2 and is formed over the insulating layer IL6. The insulating layer IL7 is also made of, for example, an inorganic insulating film such as a silicon nitride film or a silicon oxide film.

Therefore, the relay electrode RE connected to the semiconductor layer OS at the contact hole CH2 and the contact portion PLG2 including the insulating layer IL7 covering the relay electrode RE are formed. As a result, the relay electrode RE is electrically connected to the semiconductor layer OS via the contact portion PLG2. In other words, the relay electrode RE is electrically connected to the drain of the thin film transistor.

And, as illustrated in FIG. 5, the color filter CFB and the color filter CFG are formed on the insulating layer IL7. As a result, in the present embodiment, the “COA structure” is achieved. Next, an organic insulating film 100A is formed so as to cover the color filter CFB and the color filter CFG. The organic insulating film 100A is made of, for example, an organic material represented by an acrylic resin. In the organic insulating film 100A and the insulating layer IL7, a contact hole CH3 penetrating the organic insulating film 100A and the insulating layer IL7 and reaching the relay electrode RE is formed. A plurality of types of components are embedded in the contact hole CH3 to configure the contact portion PLG3. In this manner, at the contact portion PLG3, the pixel electrode PE is electrically connected to the semiconductor layer OS (drain side) via the relay electrode RE.

Next, inside and outside configurations of the contact portion PLG3 will be explained. In FIG. 5, the relay electrode RE is provided on the insulating layer IL6, and the insulating layer IL7 is arranged so as to cover the relay electrode RE. The color filter CFB and the color filter CFG are provided on the insulating layer IL7. In order to flatten the roughness due to the color filter CFB and the color filter CFG, the organic insulating film 100A is provided so as to cover the color filter CFB and the color filter CFG.

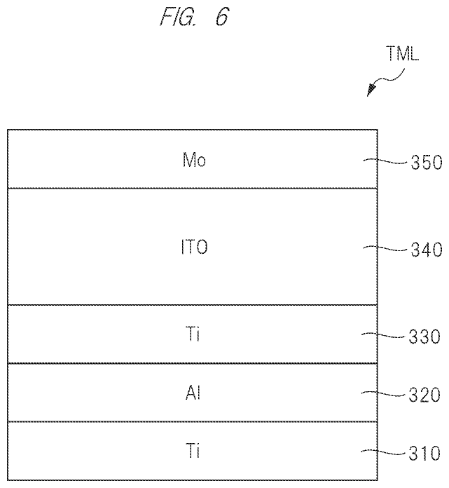

And, as illustrated in FIG. 5, in the organic insulating film 100A, the contact hole CH3 penetrating the organic insulating film 100A and the insulating layer IL7 and reaching the relay electrode RE is formed. For example, the pixel electrode PE made of a light transmitting conductive material represented by ITO is formed on the inner wall of the contact hole CH3. As illustrated in FIG. 6, the pixel electrode PE is electrically connected to the relay electrode RE at the bottom portion of the contact hole CH3. Further, in the contact hole CH3, a capacitance insulating film CI being in contact with the pixel electrode PE and the inner wall of the contact hole CH3 is formed. The capacitance insulating film CI is made of, for example, a silicon nitride film. Next, the conductive film TML being in contact with the capacitance insulating film CI, the common electrode CE being in contact with the conductive film TML, and an organic insulating film 100B being in contact with the common electrode CE and filling the contact hole CH3 are formed in the contact hole CH3.

Here, the capacitance is made of the pixel electrode PE, the capacitance insulating film CI and the common electrode CE. When the potential difference is generated between the pixel electrode PE and the common electrode CE, the electric field is induced between the pixel electrode PE and the common electrode CE. Although not illustrated in FIG. 5, the common electrode CE is provided with the slit, and the electric field leaks from the slit to the outside of the capacitance. And, the orientation directions of the liquid crystal molecules are controlled based on the electric field leaking from the slit.

The common electrode CE is made of, for example, a light transmitting conductive material such as ITO. In order to reduce a resistance of the common electrode CE, the conductive film TML being in contact with the common electrode CE is provided. That is, the conductive film TML has a function of reducing the resistance of the common electrode CE.

A configuration example of the conductive film TML will be explained below. FIG. 6 is a schematic view illustrating the configuration example of the conductive film TML.

In FIG. 6, the conductive film TML is made of a stacked film of a titanium film 310, an aluminum film 320, a titanium film 330, an ITO film 340, and a molybdenum film 350. That is, the conductive film TML is configured to include a metal film and a light transmitting conductive film (metal oxide film). For example, the titanium film 310, the aluminum film 320, the titanium film 330, and the molybdenum film 350 configuring a part of the conductive film TML are metal films having low resistance, and thus, these metal films have a function of reducing the resistance of the common electrode CE. On the other hand, the ITO film 340 is a light transmitting conductive film and is configured such that a phase difference between light transmitted via the ITO film 340 and reflected by the titanium film 330 and light reflected by the surface of the ITO film 340 is 180 degrees. As a result, the light transmitted via the ITO film 340 and reflected by the titanium film 330 and the light reflected by the surface of the ITO film 340 are offset by interference, and as a result, the reflection of the external light is suppressed. In this manner, the conductive film TML also has a function as an antireflection film that suppresses the reflection of the external light.

Next, in FIG. 5, the liquid crystal layer LC is arranged on the upper side of the organic insulating film 100A including the contact portion PLG3 formed therein to interpose the orientation film 200A therebetween, and the upper side of the contact portion PLG3 is provided with a spacer SP. A substrate 20 is arranged on the liquid crystal layer LC to interpose an orientation film 200B and an overcoat film OC therebetween. As described above, the cross-sectional configuration of the subpixels is achieved.

### <Operation of Subpixel>

Next, the operation of the subpixel will be briefly explained. For example, by supply of the scan signal to the gate electrode GE1 and the gate electrode GE2 of the thin film transistor that is one of the components of the subpixel, the gate voltage equal to or larger than the threshold voltage is applied to each of the gate electrode GE1 and the gate electrode GE2. Accordingly, the channel is formed on both the lower surface and the upper surface of the semiconductor layer OS interposed between the gate electrode GE1 and the gate electrode GE2. As a result, the source and the drain of the thin film transistor are electrically connected to turn on the thin film transistor. At this time, for example, by supply of the video signal to the source electrode SE of the thin film transistor, this video signal is transmitted via the turned-on thin film transistor to the relay electrode RE electrically connected to the drain of the semiconductor layer OS. Then, the video signal is transmitted from the relay electrode RE to the pixel electrode PE via the contact portion PLG3.

A capacitance made of the pixel electrode PE, the common electrode CE, and the capacitance insulating film CI is formed inside and outside the contact portion PLG3, and the video signal is supplied to the pixel electrode PE configuring the capacitance. As a result, a potential difference is generated between the pixel electrode PE and the common electrode CE, and an electric field generated based on the potential difference leaks from the slit provided in the common electrode CE. Also, by the transverse electric field leaking from the slit, the orientation directions of the plurality of liquid crystal molecules configuring the liquid crystal layer LC arranged on the upper side of the array substrate are controlled. As a result, transmission and shielding of light emitted from the liquid crystal layer LC are controlled in the subpixel. Such control is performed on all the subpixels arranged in the display region to display the image in the display region.

### <Explanation for Related Art>

Next, a related art will be explained with reference to the above description. The “related art” described in the present specification is not a publicly-known technique but a technique that has a problem found by the present inventors, and is a technique that is a premise of the present invention.

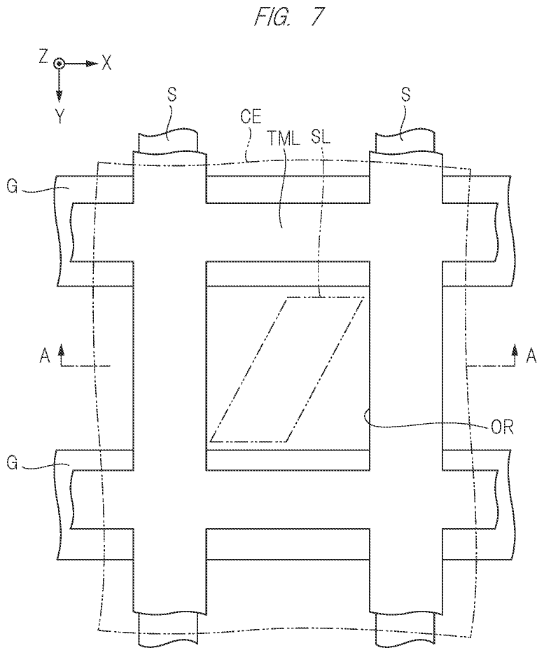

FIG. 7 is a simplified schematic plan view of FIG. 4. FIG. 7 shows two scan lines G extending in the X direction and two signal lines S intersecting these scan lines G and extending in the Y direction. The conductive film TML is arranged on the upper side of the scan line G and the signal line S. The conductive film TML includes an X-direction extending portion extending in the X direction and a Y-direction extending portion extending in the Y direction. The X-direction extending portion is provided so as to overlap the scan line G in a planar manner. On the other hand, the Y-direction extending portion is provided so as to overlap the signal line S in a planar manner. The conductive film TML has a grid-pattern planar shape made of the X-direction extending portion and the Y-direction extending portion as a whole as illustrated in FIG. 7.

An opening region OR of the subpixel is formed in a region surrounded by the grid-pattern conductive film TML. Further, as illustrated in FIG. 7, the common electrode CE is provided so as to overlap the entire elements such as the scan line G, the signal line S, and the conductive film TML in a planar manner. At this time, in the opening region OR, the common electrode CE is provided with the slit SL.

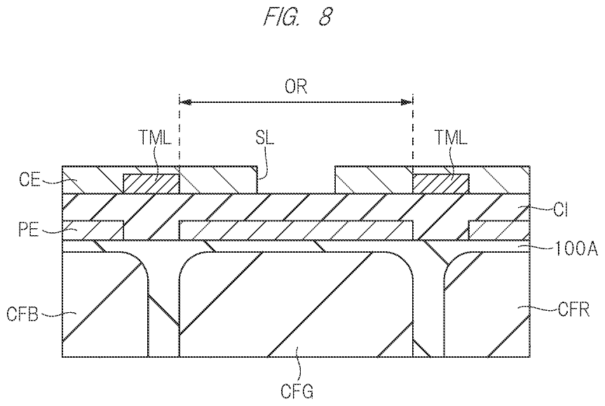

FIG. 8 is a schematic cross-sectional view taken along a line A-A in FIG. 7. In FIG. 8, the organic insulating film 100A is formed so as to cover the color filters CFB, CFG and CFR arranged to separate from one another. As illustrated in FIG. 8, the pixel electrode PE is provided so as to be in contact with the organic insulating film 100A. Further, the capacitance insulating film CI is arranged so as to cover the pixel electrode PE, and the common electrode CE is arranged so as to be in contact with the capacitance insulating film CI. At this time, in order to reduce the resistance value of the common electrode CE, the conductive film TML covered with the common electrode CE is formed on the capacitance insulating film CI. And, the common electrode CE is provided with the slit SL. Note that a capacitance is made of the pixel electrode PE, the common electrode CE, and the capacitance insulating film CI.

### <Room to be Improved>

Next, a room to be improved in the related art will be explained. In order to improve the visual recognition, it is necessary to reduce the reflection of the external light. In this regard, it is considerable that, for example, the reflection of the external light in FIG. 7 includes reflection on a region where the conductive film TML is formed and reflection on the opening region OR.

In the related art, the conductive film TML is made of not only the titanium film 310, the aluminum film 320 and the titanium film 330 as illustrated in FIG. 6, but also the ITO film 340 and the molybdenum film 350. Therefore, in the conductive film TML of the related art, the thin film interference due to the ITO film 340, the molybdenum film 350 and the common electrode (light-transmitting electrode) is caused depending on the combination of the conductive film TML and the common electrode arranged on the conductive film TML, and, as a result, the reflection of the external light emitted from the conductive film TML can be suppressed. That is, the related art adopts a devisal for suppressing the reflection of the external light emitted from the region where the conductive film TML is formed, by improvement of the structure of the conductive film TML. Therefore, in the related art, the reflection of the external light emitted from the region where the conductive film TML is formed can be suppressed.

On the other hand, in the related art, attention is not paid to the reflection of the external light emitted from the opening region OR. That is, in order to reduce the reflection of the external light, it is effective to suppress not only the reflection of the external light emitted from the region where the conductive film TML is formed but also the reflection of the external light emitted from the opening region OR. Therefore, the related art has the room to be improved in terms of the reduction of the reflection of the external light.

Accordingly, the present embodiment adopts a devisal for overcoming the room to be improved in the related art. Specifically, in the present embodiment, attention is also paid to the reflection of the external light emitted from the opening region OR to which the attention is not paid in the related art, and the devisal for not only suppressing the reflection of the external light emitted from the region where the conductive film TML is formed but also reducing the reflection of the external light emitted from the opening region OR has been made. The technical idea of the present embodiment with this devisal will be explained below.

### Basic Idea of Embodiment

The basic idea of the present embodiment is an idea for suppressing the reflection of the external light by achieving the antireflection structure on the array substrate that is the component of the display panel. This basic idea includes a first idea that achieves the antireflection structure on the array substrate under use of an already-arranged film on the array substrate by adding a new film to be in contact with the already-arranged film and a second idea that achieves the antireflection structure on the array substrate by changing a type of the already-arranged film on the array substrate.

The basis idea is made under use of an antireflection mechanism of the antireflection film made of, for example, a stacking structure of a high-refractive-index film and a low-refractive-index film. Specifically, the antireflection mechanism of the antireflection film made of the stacking structure of the high-refractive-index film and the low-refractive-index film is described as follows. That is, when the light is made incident from the upper side of the high-refractive-index film formed on the low-refractive-index film, a part of the light is reflected on a surface of the high-refractive-index film while another part of the light penetrates the high-refractive-index film. The light having penetrated the high-refractive-index film is reflected on an interface between the high-refractive-index film and the low-refractive-index film because of difference between a refractive index of the high-refractive-index film and a refractive index of the low-refractive-index film. Therefore, the reflected light returning to the upper side of the high-refractive-index film includes first reflected light reflected on the surface of the high-refractive-index film and second reflected light reflected on the interface between the high-refractive-index film and the low-refractive-index film.

In this case, if a film thickness of the high-refractive-index film is set such that a phase difference between the first reflected light and the second reflected light is 180 degrees, the first reflected light and the second reflected light interfere each other to weaken each other. As a result, intensity of the reflected light returning to the upper side of the high-refractive-index film is reduced. As described above, the antireflection film made of the stacking structure of the high-refractive-index film and the low-refractive-index film reduces the reflection because of using the antireflection mechanism that is called thin film interference.

In this regard, in the basic idea, the reflection of the external light emitted from the display panel is suppressed by the achievement of the antireflection structure on the array substrate under the use of this antireflection mechanism (thin film interference). Particularly, the first idea included in the basic idea is the idea that achieves the antireflection structure on the array substrate under the use of the already-formed low-refractive-index film on the array substrate by adding the new high-refractive-index film to be in contact with this low-refractive-index film. On the other hand, the second idea included in the basic idea is the idea that achieves the antireflection structure on the array substrate by changing the already-formed low-refractive-index film on the array substrate to the high-refractive-index film.

An embodied aspect provided by embodying the basic idea will be explained below. Particularly in a section “Embodied Aspect”, an embodied example of the first idea included in the basic idea will be explained. On the other hand, in a section “Modification Example”, an embodied example of the second idea included in the basic idea will be explained.

### <Embodied Aspect>

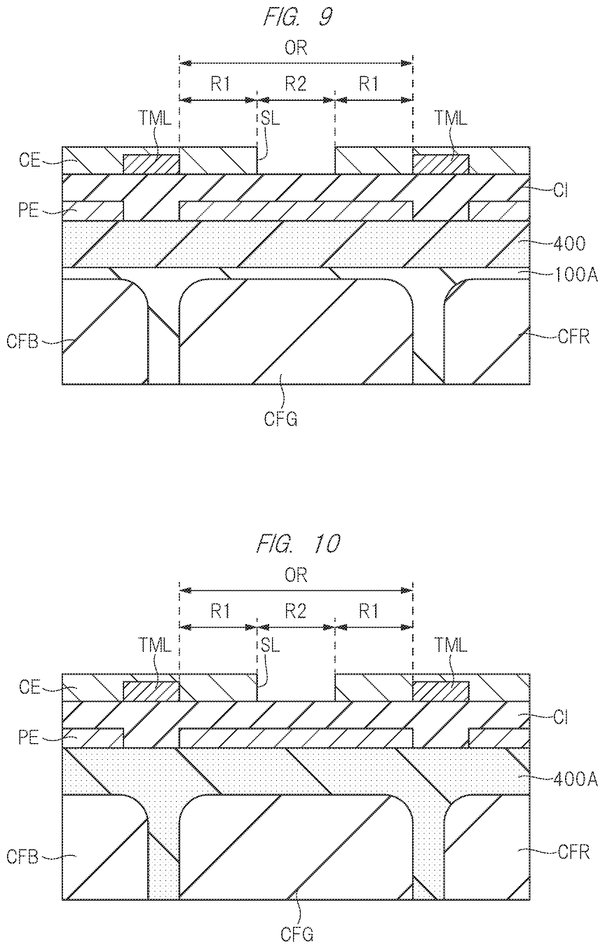

FIG. 9 is a view for explaining the array substrate of the embodied aspect, and is a schematic cross-sectional view corresponding to a cross sectional taken along the line A-A in FIG. 7. Particularly, FIG. 9 shows the region where the conductive film TML is formed and the opening region OR. The opening region OR includes a region R1 (covered region) covered with the common electrode CE and a region R2 (slit region) where the slit SL is formed. In FIG. 9, note that a lower structure than the color filters CFB, CFG and CGR is omitted. In other words, although a substrate (light-transmitting substrate) on which a switching element is formed exists on the lower side of the color filters CFB, CFG and CGR (see FIG. 5), illustration of such a component is omitted in FIG. 9.

In FIG. 9, the organic insulating film 100A is formed so as to cover the color filters CFB, CFG and CFR arranged to separate from one another. And, a high-refractive-index film 400 is arranged to be in contact with this organic insulating film 100A. A refractive index of the high-refractive-index film 400 is higher than a refractive index of the organic insulating film 100A. For example, the refractive index of the organic insulating film 100A is about 1.5. On the other hand, the refractive index of the high-refractive-index film 400 is equal to or higher than 1.7 and equal to or lower than 1.9. The high-refractive-index film 400 is made of, for example, a silicon nitride film.

Next, as illustrated in FIG. 9, the pixel electrode PE being in contact with the high-refractive-index film 400 is formed on the high-refractive-index film 400. The pixel electrode PE is made of, for example, a light-transmitting conductive material such as ITO. On the pixel electrode PE, the capacitance insulating film CI being in contact with the pixel electrode PE is formed. The capacitance insulating film CI is made of, for example, a silicon nitride film.

Subsequently, as illustrated in FIG. 9, on the capacitance insulating film CI, the common electrode CE being in contact with the capacitance insulating film CI, is formed. The common electrode CE is made of, for example, a light transmitting conductive material such as ITO. In order to reduce the resistance value of the common electrode CE, the conductive film TML covered with the common electrode CE is formed on the capacitance insulating film CI. As illustrated in FIG. 9, the common electrode CE is provided with the slit SL.

### <<Feature of Embodied Aspect>>

Next, a feature of an embodied aspect will be explained. The feature of the embodied aspect is that, for example, the high-refractive-index film 400 is provided on the organic insulating film 100A as illustrated in FIG. 9. In this case, the organic insulating film 100A is made of, for example, a low-refractive-index film having a refractive index of about 1.5. On the other hand, the high-refractive-index film 400 is made of, for example, an insulating film having a refractive index that is equal to or higher than 1.7 and equal to or lower than 1.9. Specifically, the organic insulating film 100A is made of an organic material represented by an acrylic resin. On the other hand, the high-refractive-index film 400 is made of a silicon nitride film.

Therefore, the antireflection structure made of the low-refractive-index film (organic insulating film 100A) and the high-refractive-index film 400 is achieved. Particularly in the embodied aspect illustrated in FIG. 9, the first idea is embodied by the achievement of the antireflection structure on the array substrate under use of the already-arranged low-refractive-index film (organic insulating film 100A) on the array substrate by newly adding the high-refractive-index film 400 to be in contact with this low-refractive-index film.

In the embodied aspect illustrated in FIG. 9, the region where the conductive film TML is formed and the antireflection structure made of the organic insulating film 100A and the high-refractive-index film 400 formed over the opening region OR are provided. Therefore, according to the embodied aspect, the reflection of the external light even on the opening region OR to which the attention is not paid in the related art can be reduced by the antireflection structure. Therefore, according to the embodied aspect, not only the reflection of the external light emitted from the region where the conductive film TML is formed but also the reflection of the external light emitted from the opening region OR can be suppressed. Therefore, according to the embodied aspect, the reflection of the external light can be suppressed more than that of the related art.

In terms of the effective suppression of the reflection of the external light by the antireflection structure, note that it is effective to design the film thickness of the high-refractive-index film 400 to be a film thickness easily generating the thin film interference. For example, if each of both the high-refractive-index film 400 and the capacitance insulating film CI is made of the silicon nitride film, the film thickness of the high-refractive-index film 400 is desirably equal to the film thickness of the capacitance insulating film CI or larger than the film thickness of the capacitance insulating film CI.

### Modification Example

Next, the present modification example will be explained. FIG. 10 is a view for explaining an array substrate of the modification example and is a schematic cross-sectional view corresponding to the cross section taken along the line A-A in FIG. 7. In FIG. 10, note that the lower structure than the color filters CFB, CFG and CFR will be omitted. In FIG. 10, in the present modification example, a high-refractive-index film 400A is provided so as to cover the color filters CFB, CFG and CFR arranged to separate from one another. That is, the present modification example adopts the high-refractive-index film 400A having the refractive index that is equal to or higher than 1.7 and equal to or lower than 1.9 in place of the organic insulating film 100A that is the low-refractive-index film having the refractive index of about 1.5. This high-refractive-index film 400A may be made of, for example, a silicon nitride film.

Therefore, in the present modification example, the second idea that achieves the antireflection structure on the array substrate is embodied by changing the regularly-arranged low-refractive-index film (organic insulating film 100A) on the array substrate to the high-refractive-index film 400A. In this case, the color filters CFB, CFG and CFR themselves function as the low-refractive-index film, and the antireflection structure is achieved by the combination of the high-refractive-index film 400A being in contact with and covering the color filters CFB, CFG and CFR and the color filters CFB, CFG and CFR functioning as the low-refractive-index film.

Particularly, also in the present modification example, the region where the conductive film TML is formed and the antireflection structure made of the low-refractive-index film and the high-refractive-index film formed over the opening region OR are provided. Therefore, according to the modification example, the reflection of the external light even on the opening region OR to which the attention is not paid in the related art can be reduced by the antireflection structure. Therefore, according to the modification example, not only the reflection of the external light emitted from the region where the conductive film TML is formed but also the reflection of the external light emitted from the opening region OR can be also suppressed. Therefore, according to the modification example, the reflection of the external light can be suppressed more than that of the related art.

In the scope of the idea of the present invention, various modification examples and alteration examples could have been easily anticipated by those who are skilled in the art, and it would be understood that these various modification examples and alteration examples are within the scope of the present invention. For example, the ones obtained by appropriate addition, removal, or design-change of the components to/from/into each of the above-described embodiments by those who are skilled in the art or obtained by addition, omitting, or condition-change of the step to/from/into each of the above-described embodiments are also within the scope of the present invention as long as they include the idea of the present invention.

In addition, it would be understood that, among other operations and effects caused by the aspects described in the embodiments, clear operations and effects from the present specification or operations and effects appropriately conceived by those skilled in the art are obviously brought by the present invention.

What is claimed is:

1. A display apparatus comprising:
an organic insulating film;
a high-refractive-index film being in contact with the organic insulating film;
a pixel electrode being in contact with the high-refractive-index film;
a capacitance insulating film being in contact with the pixel electrode; and
a common electrode being in contact with the capacitance insulating film,
wherein a refractive index of the high-refractive-index film is higher than a refractive index of the organic insulating film.

2. The display apparatus according to claim 1,
wherein the refractive index of the high-refractive-index film is equal to or higher than 1.7 and equal to or lower than 1.9.

3. The display apparatus according to claim 1,
wherein the high-refractive-index film is a silicon nitride film.

4. The display apparatus according to claim 1 further comprising
a color filter being in contact with the organic insulating film,
wherein the organic insulating film is formed so as to cover the color filter.

5. A display apparatus comprising:
a color filter;
a high-refractive-index film being in contact with the color filter;
a pixel electrode being in contact with the high-refractive-index film;
a capacitance insulating film being in contact with the pixel electrode; and
a common electrode being in contact with the capacitance insulating film,
wherein a refractive index of the high-refractive-index film is higher than a refractive index of the color filter.

6. The display apparatus according to claim 5,
wherein the refractive index of the high-refractive-index film is equal to or higher than 1.7 and equal to or lower than 1.9.

7. The display apparatus according to claim 5,
wherein the high-refractive-index film is a silicon nitride film.

8. An array substrate comprising:
a color filter;
a high-refractive-index film being in contact with the color filter;
a pixel electrode being in contact with the high-refractive-index film;
a capacitance insulating film being in contact with the pixel electrode; and
a common electrode being in contact with the capacitance insulating film,
wherein a refractive index of the high-refractive-index film is higher than a refractive index of the color filter.

9. The array substrate according to claim 8,
wherein the refractive index of the high-refractive-index film is equal to or higher than 1.7 and equal to or lower than 1.9.

10. The array substrate according to claim 8,
wherein the high-refractive-index film is a silicon nitride film.
